(19) United States
(12) Patent Application Publication
(10) Pub. No.: US 2010/0035564 A1
(43) Pub. Date: Feb. 11, 2010

(54) MOBILE COMMUNICATION TERMINAL CASE AND MOBILE COMMUNICATION TERMINAL

(75) Inventor: Dae Kyu LEE, Suwon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 12/332,116

(22) Filed: Dec. 10, 2008

(30) Foreign Application Priority Data
Aug. 5, 2008 (KR) 10-2008-0076481

(51) Int. Cl. H04B 1/38

(52) U.S. Cl. 455/90.3

(57) ABSTRACT

A mobile communication terminal case according to an aspect of the invention: a case body having a first surface and a second surface opposite to the first surface; a support portion provided on the first surface of the case body and having a connector insertion space; and a film type antenna having a carrier film and a conductive pattern provided on the carrier film, and provided on the first surface of the case body to expose a region of the conductive pattern to the connector insertion space.

### CROSS-REFERENCE TO RELATED APPLICATIONS

This application claims the priority of Korean Patent Application No. 2008-0076481 filed on Aug. 5, 2008, in the Korean Intellectual Property Office, the disclosure of which is incorporated herein by reference.

### BACKGROUND OF THE INVENTION

1. Field of the Invention

The present invention relates to mobile communication terminal cases and mobile communication terminals, and more particularly, to a mobile communication terminal case that has a structure for providing a stable contact between an antenna and a board when the antenna formed on the surface of the case of the mobile communication terminal is connected to the board disposed inside the case of the mobile communication terminal, and a mobile communication terminal.

2. Description of the Related Art

Recently, mobile wireless terminals that separately use various kinds of bandwidths, such as CDMA, PDA, DCS, and GSM, or use all of the bandwidths, have come into widespread use. Terminals that have various kinds of functions and designs have correspondingly appeared. As the terminals have gradually been reduced in size, thickness, and weight, the diversity of the functions of the terminals has attracted attention. Therefore, emphasis is placed on reducing the volume of the terminals while the terminals maintain the function of an antenna.

Particularly, in a case of an antenna, for example, a rod antenna or a helical antenna that protrudes from the outside of a terminal by a predetermined length has excellent characteristics because of omnidirectional radiation. However, the rod antenna or the helical antenna of the terminal is most susceptible to damage when it falls down, and reduces portability. Therefore, research has been conducted on an in-molding antenna that is formed integrally with a case of a mobile communication terminal.

### SUMMARY OF THE INVENTION

An aspect of the present invention provides a mobile communication terminal case and a mobile communication terminal that can provide a stable contact between an antenna formed on the surface of a case of a mobile communication terminal and a printed circuit board inside the case.

According to an aspect of the present invention, there is provided a mobile communication terminal case including: a case body having a first surface and a second surface opposite to the first surface; a support portion provided on the first surface of the case body and having a connector insertion space; and a film type antenna having a carrier film and a conductive pattern provided on the carrier film, and provided on the first surface of the case body to expose a region of the conductive pattern to the connector insertion space.

The support portion may include a horizontal tunnel having the connector insertion space arranged parallel to a major surface of the case body.

The support portion may include a vertical tunnel having the connector insertion space perpendicular to a major surface of the case body.

The first surface of the case body may be an inner surface of the mobile communication terminal case.

According to another aspect of the present invention, there is provided a mobile communication terminal including: a case body having a first surface and a second surface opposite to the first surface; a support portion provided on the first surface of the case body, and having a connector insertion space; a film type antenna having a carrier film, a conductive pattern provided on the carrier film, and provided on the first surface of the case body to expose a region of the conductive pattern to the connector insertion space; a circuit board provided on the support portion; and a connector at least partially inserted into the connection insertion space and in contact with the conductive pattern and the circuit board.

The support portion may include a horizontal tunnel having the connector insertion space arranged parallel to a major surface of the case body.

The connector may include a curved plate including: a first region in contact with the conductive pattern; and a second region in contact with the circuit board.

The plate-like connector may include a protrusion provided on the first region to make a point contact between the connector and the conductive pattern.

The support portion may include a vertical tunnel having the connector insertion space arranged perpendicular to a major surface of the case body.

The connector may be shaped like a C-clip.

The first surface of the case body may be an inner surface of the mobile communication terminal case.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a perspective view illustrating a mobile communication terminal case according to an exemplary embodiment of the invention;

FIG. 1B is a cross-sectional view illustrating the mobile communication terminal case according to the embodiment illustrated in FIG. 1A;

FIG. 2 is a perspective view illustrating a mobile communication terminal case according to another exemplary embodiment of the invention;

FIG. 3A is a cross-sectional view illustrating a mobile communication terminal according to an exemplary embodiment of the invention;

FIGS. 3B through 3D are views various examples of a connected used in the mobile communication terminal according to the embodiment illustrated in FIG. 3A; and

FIG. 4 is a cross-section view illustrating a mobile communication terminal according to another exemplary embodiment of the invention.

### DETAILED DESCRIPTION OF THE PREFERRED EMBODIMENT

Exemplary embodiments of the present invention will now be described in detail with reference to the accompanying drawings.

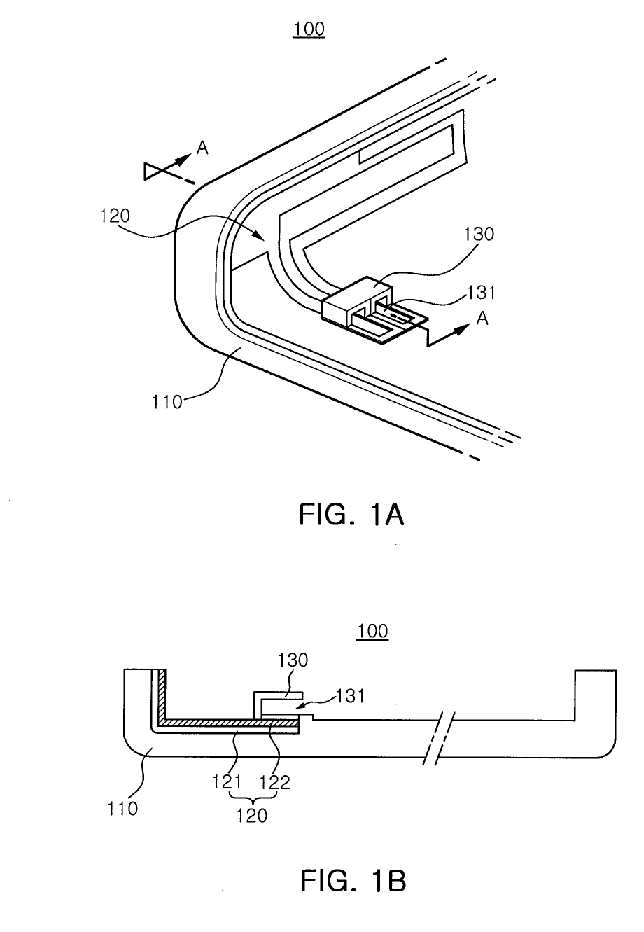

FIG. 1A is a perspective view illustrating a case of a mobile communication terminal according to an exemplary embodiment of the invention. FIG. 1B is a cross-sectional view illustrating the case of the mobile communication terminal according to the embodiment illustrated in FIG. 1A.

Referring to FIGS. 1A and 1B, a mobile communication terminal case 100 according to this embodiment may include a case body 110, a film type antenna 120, and a support portion 130.

The case body 110 may be formed integrally with the film type antenna 120 by using an in-molding process. That is, a carrier film 121 having the conductive pattern 122 formed thereon is inserted into a mold used to manufacture the case body. Synthetic resin for manufacturing the case body is injected into the mold to thereby manufacture the case body. In this embodiment, the conductive pattern 122 formed on the carrier film 121 may be exposed on an inner surface of the case body 110.

The film type antenna 120 may be formed on the inner surface of the case body 110. In the film type antenna 120, the conductive pattern 122 may be formed on the carrier film 121. The conductive pattern 122 may be an antenna pattern.

The carrier film 121 may be formed of a material that is appropriate to perform in-molding labeling (IML). Specifically, the carrier film 121 that has the conductive pattern 122 formed on one surface thereof is inserted into a mold for manufacturing a housing of the mobile communication terminal, synthetic resin used to form the housing of the mobile communication terminal is injected into the mold, and the housing is molded from the synthetic resin at optimum temperature and optimum pressure. Therefore, the material that forms the carrier film needs to be a material that does not undergo significant deformation under the pressure and temperature during the in-molding labeling, and at the same time, can be formed integrally with the housing of the mobile communication terminal. In this embodiment, the carrier film 121 may include a thin, insulating polymer material.

The conductive pattern 122 may be formed by using various kinds of methods. First, a conductive pattern may be printed onto the carrier film 121 by using conductive ink. Alternatively, a desired pattern may be directly formed on the carrier film by sputtering or evaporation. The conductive pattern 122 may be a conductive pattern that is formed of previously manufactured metal foil which is then attached to the carrier film 121.

The conductive pattern 122 includes a power feeding terminal, and may additionally include a connection terminal for providing an electrical connection to an external circuit, such as a ground terminal. In this embodiment, the power feeding terminal may be exposed to a connector insertion space 131 of the support portion.

The support portion 130 may be formed integrally with the case body 110 to form the connector insertion space 131. In this embodiment, the support portion 130 may be configured as a horizontal tunnel in which the connector insertion space 131 is arranged parallel to the major surface of the case body 110. The support portion 130 may be formed together with the case body 110 by using injection molding.

A region of the conductive pattern 122 may be exposed to the connector insertion space 131. The exposed region of the conductive pattern may be connected to a board disposed inside the case of the mobile communication terminal through a connector that is inserted into the connector insertion space 131.

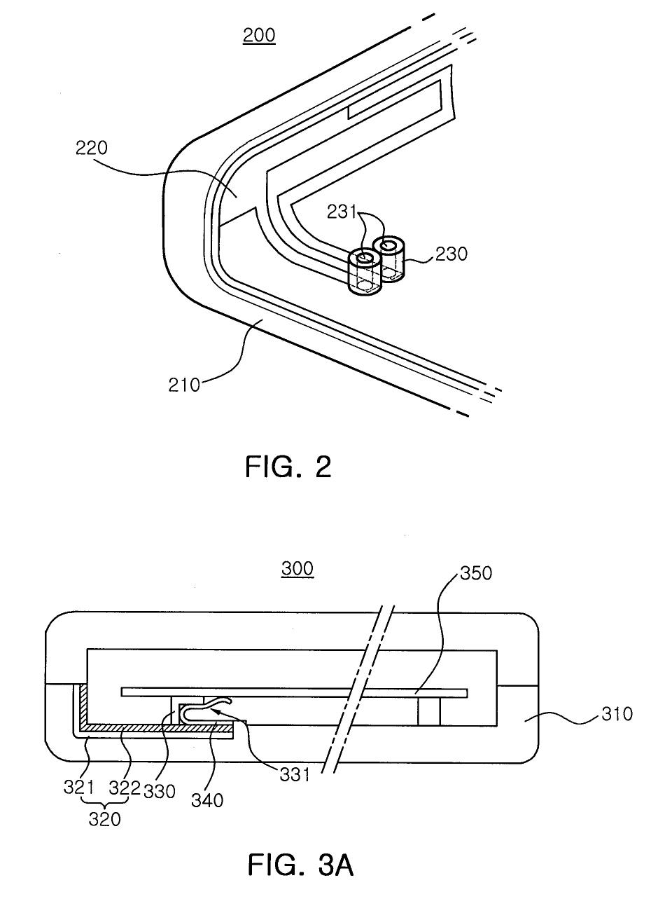

FIG. 2 is a perspective view illustrating a case of a mobile communication terminal according to another exemplary embodiment of the invention.

Referring to FIG. 2, a mobile communication terminal case 200 according to this embodiment may include a case body 210, a film type antenna 220, and a support portion 230.

The case body 210 may be formed integrally with the film type antenna 220 by using in-molding labeling. That is, a carrier film having a conductive pattern formed thereon is inserted into a mold used to manufacture the case body, and synthetic resin used to form the case body is injected into the mold, thereby manufacturing the case body. In this embodiment, the conductive pattern formed on the carrier film may be exposed on an inner surface of the case body 110. In FIG. 2, the carrier film and the conductive pattern that form the film type antenna 220 are not clearly separated. However, the antenna type antenna 220 and the case body 210 may be formed as described with reference to FIG. 1B.

The film type antenna 220 may be formed on the inner surface of the case body 210. In the film type antenna 220, the conductive pattern may be formed on the carrier film. The conductive pattern may be an antenna pattern.

The carrier film may be formed of a material that is appropriate to perform in-molding labeling (IML). Specifically, the carrier film that has the conductive pattern formed on one surface thereof is inserted into a mold for manufacturing a housing of the mobile communication terminal, synthetic resin used to form the housing of the mobile communication terminal is injected into the mold, and the housing is molded from the synthetic resin at optimum temperature and optimum pressure. Therefore, the material that forms the carrier film needs to be a material that does not undergo significant deformation under the pressure and temperature during the in-molding labeling, and at the same time, can be formed integrally with the housing of the mobile communication terminal. In this embodiment, the carrier film may include a thin, insulating polymer material.

The conductive pattern may be formed by using various kinds of methods. First, a conductive pattern may be printed onto the carrier film by using conductive ink. Alternatively, a desired pattern may be directly formed on the carrier film by sputtering or evaporation. The conductive pattern may be a conductor pattern that is formed of previously manufactured metal foil which is then attached to the carrier film.

The conductive pattern may include a power feeding terminal, and may also include a connection terminal for providing an electrical connection to an external circuit, such as a ground terminal. In this embodiment, the power feeding terminal may be exposed to a connector insertion space 231 of the support portion.

The support portion 230 may be formed integrally with the case body to form the connector insertion space 231. In this embodiment, the support portion 230 may be configured as a vertical tunnel in which the connector insertion space 231 is formed along a perpendicular direction to a major surface of the case body. The support portion 230 may be formed together with the case body 210 by injection molding.

A region of the conductive pattern of the film type antenna 220 may be exposed to the connector insertion space 231. The exposed region of the conductive pattern may be connected to a board disposed inside the case of the mobile communication terminal by using the connector that is inserted into the connector insertion space 231.

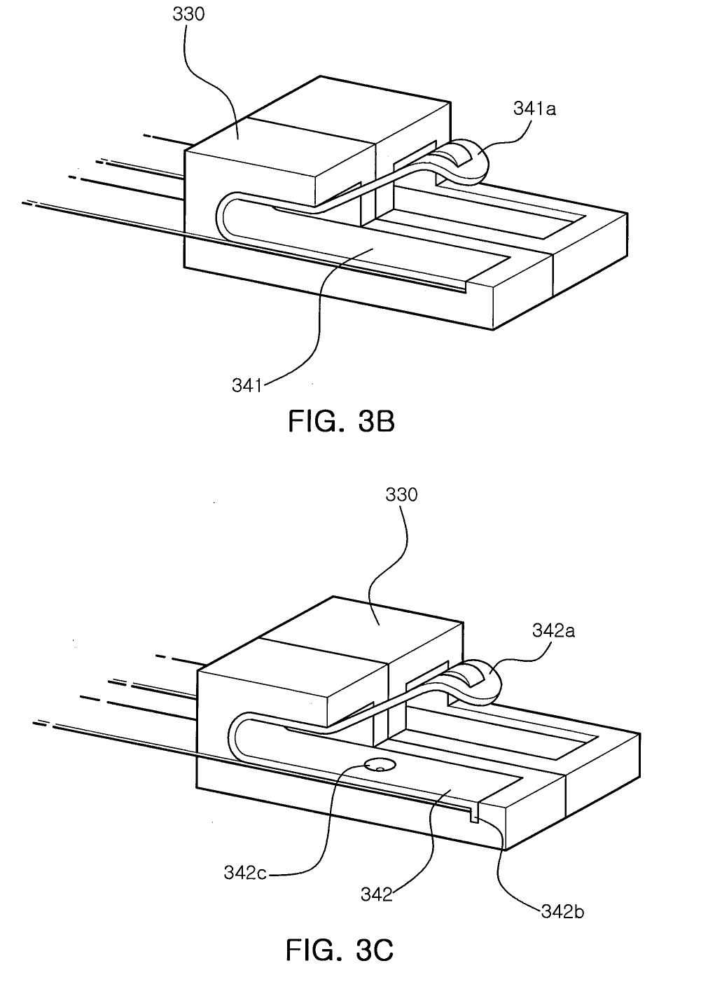

FIG. 3A is a cross-sectional view illustrating a mobile communication terminal according to an exemplary embodiment of the invention. FIGS. 3B through 3D are views illustrating various examples of a connector used in the mobile communication terminal.

Referring to FIG. 3A, a mobile communication terminal 300 according to this embodiment may include a case body 310, a film type antenna 320, a support portion 330, a circuit board 350, and a connector 340.

The case body 310 may be formed integrally with the film type antenna 320 by using in-molding labeling. That is, the carrier film 321 having the conductive pattern 322 formed thereon is injected into a mold for manufacturing a case, and synthetic resin used to form the case body is injected into the mold. In this embodiment, the conductive pattern 322 formed on the carrier film 321 may be exposed on an inner surface of the case body 310.

The film type antenna 320 may be formed on the inner surface of the case body 310. In the film type antenna 320, the conductive pattern 322 may be formed on the carrier film 321. The conductive pattern 322 may be an antenna pattern.

The carrier film 321 may be formed of a material that is appropriate to perform in-molding labeling (IML). Specifically, the carrier film 321 having the conductive pattern 322 formed on one surface thereof is inserted into a mold for manufacturing a housing of the mobile communication terminal, synthetic resin used to form the housing of the mobile communication terminal is injected into the mold, and the housing is molded from the synthetic resin at optimum temperature and optimum pressure. Therefore, the material that forms the carrier film needs to be a material that does not undergo significant deformation under the pressure and temperature during the in-molding labeling, and at the same time, can be formed integrally with the housing of the mobile communication terminal. The carrier film 321 may include a thin, insulating polymer material.

The conductive pattern 322 may be formed by using various kinds of methods. First, a conductive pattern may be printed onto the carrier film 321 by using conductive ink. Alternatively, a desired pattern may be directly formed on the carrier film by sputtering or evaporation. The conductive pattern 322 may be a conductor pattern that is formed of previously manufactured metal foil which is then attached to the carrier film.

The conductive pattern 322 includes a power feeding terminal, and may additionally include a connection terminal for providing an electrical connection to an external circuit, such as a ground terminal. In this embodiment, the power feeding terminal may be exposed to a connector insertion space 331 of the support portion.

The support portion 330 may be formed integrally with the case body 310 to form the connector insertion space 331. In this embodiment, the support portion 330 may be configured as a horizontal tunnel in which the connector insertion space 331 is arranged parallel to a major surface of the case body 310. The support portion 330 may be formed together with the case body 310 by using injection molding.

A region of the conductive pattern 322 may be exposed to the connector insertion space 331. The exposed region of the conductive pattern may be connected to the circuit board 350 disposed in the case of the mobile communication terminal by using the connector 340 inserted into the connector insertion space 331.

The circuit board 350 is disposed inside the case of the mobile communication terminal, and a plurality of elements may be mounted onto the circuit board 350. The circuit board 350 may be supported against the inside of the case of the mobile communication terminal by the support portion 330.

The connector 340 is inserted into the connector insertion space 331 of the support portion 330, and may be used as an electrical connection path between the conductive pattern 322 and the circuit board 350. In this embodiment, the connector 340 may be formed into a curved plate. The connector 340 may be in contact with the region of the conductive pattern 322 that is exposed to the connector insertion space 331.

Referring to FIG. 3B, a connector 341 according to this embodiment may be configured as a curved plate. When the connector is inserted into a connector insertion region, a height of one end 341a of the connector may be larger than that of the support portion 330. The curved shape of the connector allows the connector to have elasticity.

Referring to FIG. 3C, a connector 342 according to this embodiment may be formed into a curved plate. When the connector is inserted into a connector insertion region, a height of one end 342a of the connector may be larger than that of the support portion 330. The curved shape of the connector allows the connector to have elasticity. The other end 342b of the connector may be caught by a groove formed in the case body, and thus firmly fixed.

In this embodiment, a protrusion 342c may be formed at a region of the connector which is in contact with the conductive pattern. The formation of the protrusion 342c allows a point contact between the connector and the conductive pattern to thereby increase a contact force therebetween.

Referring to FIG. 3D, a connector 343 according to this embodiment may be shaped like a curved plate. When the connector is inserted into a connector insertion region of the support portion, a height of one end 343a of the connector may be larger than that of the support portion 330. The curved shape of the connector allows the connector to have elasticity. The other end 343b of the connector may be caught in a groove formed in the case body, and thus firmly fixed.

In this embodiment, a protrusion 343c may be formed on a region of the connector which is in contact with the conductive pattern. The formation of the protrusion 343c allows a point contact between the connector and the conductive pattern to thereby increase a contact force therebetween.

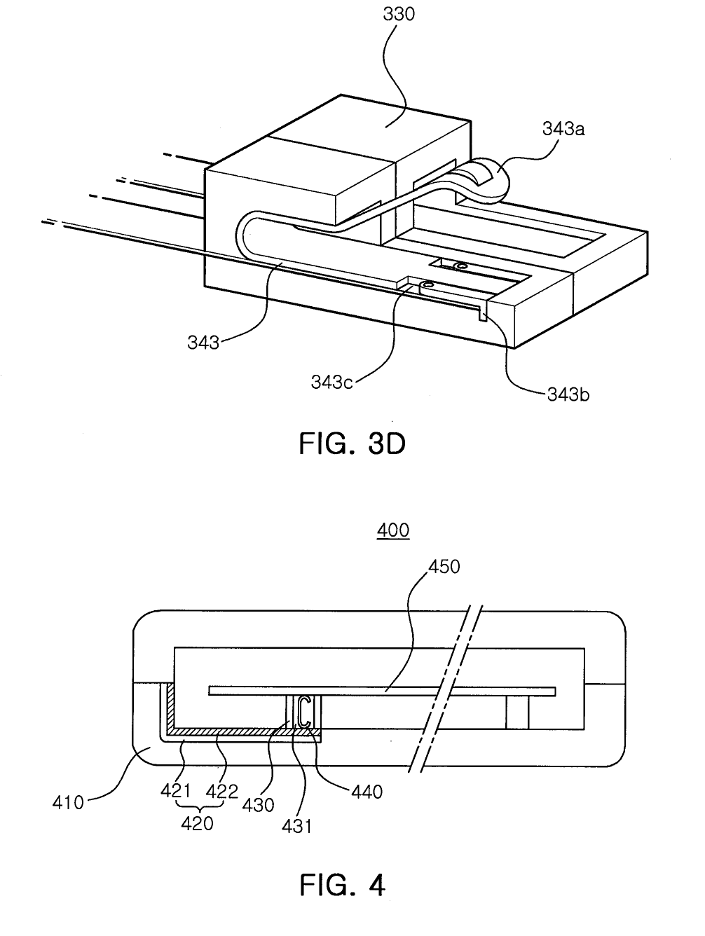

FIG. 4 is a cross-sectional view illustrating a mobile communication terminal according to another exemplary embodiment of the invention.

Referring to FIG. 4, a mobile communication terminal 400 according to this embodiment may include a case body 410, a film type antenna 420, a support portion 430, a circuit board 450, and a connector 440.

The case body 410 may be formed integrally with the film type antenna 420 by using in-molding labeling. That is, the carrier film 421 having a conductive pattern 422 formed thereon is inserted into a mold used to manufacture the case body. Synthetic resin for manufacturing the case body is injected into the mold to manufacture the case body. In this embodiment, the conductive pattern 422 formed on the carrier film 421 may be exposed to an inner surface of the case body 410.

The film type antenna 420 may be formed on the inner surface of the case body 410. In the film type antenna 420, the conductive pattern 422 may be formed on the carrier film 421. The conductive pattern 422 may be an antenna pattern.

The carrier film 421 may be formed of a material that is appropriate to perform in-molding labeling (IML). Specifically, the carrier film 421 having the conductive pattern 422 formed on one surface thereof is inserted into a mold for manufacturing a housing of a mobile communication terminal, synthetic resin used to form the housing of the mobile communication terminal is injected into the mold, and the housing is molded from the synthetic resin at optimum temperature and optimum pressure. Therefore, the material that forms the carrier film needs to be a material that does not undergo significant deformation under the pressure and temperature during the in-molding labeling, and at the same time, can be formed integrally with the housing of the mobile communication terminal. The carrier film 421 may include a thin, insulating polymer material.

The conductive pattern 422 may be formed by using various kinds of methods. First, a conductive pattern may be printed onto the carrier film 421 by using conductive ink. Alternatively, a desired pattern may be directly formed on the carrier film by sputtering or evaporation. The conductive pattern 422 may be a conductive pattern that is formed of previously manufactured metal foil which is then attached to the carrier film 421.

The conductive pattern 422 includes a power feeding terminal, and may additionally include a connection terminal for providing an electrical connection to an external circuit, such as a ground terminal. In this embodiment, the power feeding terminal may be exposed to a connector insertion space 431 of the support portion.

The support portion 430 may be formed integrally with the case body 410 to form the connector insertion space 431. In this embodiment, the support portion 430 may have a horizontal tunnel in which the connector insertion space 431 is arranged parallel to a major surface of the case body 410. The support portion 430 may be formed together with the case body 410 using injection molding.

A region of the conductive pattern 422 may be exposed to the connector insertion space 431. The exposed region of the conductive pattern may be connected to a board disposed inside the case of the mobile communication terminal by using a connector that is inserted into the connector insertion space 431.

The circuit board 450 is disposed inside the case of the mobile communication terminal, and a plurality of elements (not shown) may be mounted therein. The circuit board 450 may be supported against the inside of the case of the mobile communication terminal by the support portion 430.

The connector 440 is inserted into the connector insertion space 431 of the support portion 430, and may be used as an electrical connection path between the conductive pattern 422 and the circuit board 450. In this embodiment, the connector 440 may be formed into a C-clip. The connector 440 has one end that may be in contact with the region of the conductive pattern 422 that is exposed to the connector insertion space 441.

As set forth above, according to exemplary embodiments of the invention, a mobile communication terminal case and a mobile communication can provide a stable contact between a film type antenna formed on the surface of the case of the mobile communication terminal and a board disposed inside the mobile communication terminal.

While the present invention has been shown and described in connection with the exemplary embodiments, it will be apparent to those skilled in the art that modifications and variations can be made without departing from the spirit and scope of the invention as defined by the appended claims.

What is claimed is:

1. A mobile communication terminal case comprising:
a case body having a first surface and a second surface opposite to the first surface;
a support portion provided on the first surface of the case body and having a connector insertion space; and
a film type antenna having a carrier film and a conductive pattern provided on the carrier film, and provided on the first surface of the case body to expose a region of the conductive pattern to the connector insertion space.

2. The mobile communication terminal case of claim 1, wherein the support portion comprises a horizontal tunnel having the connector insertion space arranged parallel to a major surface of the case body.

3. The mobile communication terminal case of claim 1, wherein the support portion comprises a vertical tunnel having the connector insertion space perpendicular to a major surface of the case body.

4. The mobile communication terminal case of claim 1, wherein the first surface of the case body is an inner surface of the mobile communication terminal case.

5. A mobile communication terminal comprising:
a case body having a first surface and a second surface opposite to the first surface;
a support portion provided on the first surface of the case body, and having a connector insertion space;
a film type antenna having a carrier film, a conductive pattern provided on the carrier film, and provided on the first surface of the case body to expose a region of the conductive pattern to the connector insertion space;
a circuit board provided on the support portion; and
a connector at least partially inserted into the connection insertion space and in contact with the conductive pattern and the circuit board.

6. The mobile communication terminal of claim 5, wherein the support portion comprises a horizontal tunnel having the connector insertion space arranged parallel to a major surface of the case body.

7. The mobile communication terminal of claim 6, wherein the connector comprises a curved plate comprising:
a first region in contact with the conductive pattern; and
a second region in contact with the circuit board.

8. The mobile communication terminal of claim 7, wherein the plate-like connector comprises a protrusion provided on the first region to make a point contact between the connector and the conductive pattern.

9. The mobile communication terminal of claim 5, wherein the support portion comprises a vertical tunnel having the connector insertion space arranged perpendicular to a major surface of the case body.

10. The mobile communication terminal of claim 9, wherein the connector is shaped like a C-clip.

11. The mobile communication terminal of claim 5, wherein the first surface of the case body is an inner surface of the mobile communication terminal case.
